(19) United States
(12) Patent Application Publication
(10) Pub. No.: US 2019/0251927 A1
(43) Pub. Date: Aug. 15, 2019

(54) FLEXIBLE DISPLAY DEVICE AND DISPLAY METHOD THEREFOR

(71) Applicant: BOE TECHNOLOGY GROUP CO., LTD., Beijing (CN)

(72) Inventor: Ruoyu MA, Beijing (CN)

(21) Appl. No.: 16/316,813

(22) PCT Filed: May 9, 2018
(86) PCT No.: PCT/CN2018/086178

§ 371 Date: Jan. 10, 2019

(30) Foreign Application Priority Data
May 12, 2017 (CN) 201710333299.6

(51) Int. Cl. G09G 5/00; G09G 5/14; G01L 5/16

(52) U.S. Cl. CPC G09G 5/003; G09G 5/14; G06F 1/1652; G09G 2380/02; G01L 5/16

(57) ABSTRACT

A flexible display device and a display method thereof are provided. The method includes: determining a state of the flexible display device according to a difference between a stress received by an upper surface and a stress received by a lower surface of the flexible display device; and controlling the flexible display device to switch to a first display mode in a case where the state of the flexible display device is a curved state in which the stress received by the upper surface is not equal to the stress received by the lower surface and controlling the flexible display device to switch to a second display mode in a case where the state of the flexible display device is a planar state in which the stress received by the upper surface is equal to the stress received by the lower surface.

The present application claims priority of Chinese Patent Application No. 201710333299.6 filed on May 12, 2017, the disclosure of which is incorporated herein by reference in its entirety as part of the present application.

### TECHNICAL FIELD

Embodiments of the present disclosure relate to a flexible display device and a display method thereof.

### BACKGROUND

A flexible display device may implement different display modes through different display states. When the display mode of the flexible display device is switched, the state of the flexible display device is usually sensed by an infrared sensor provided inside the flexible display device.

Since the infrared sensor is less sensitive to the state of the flexible display device, simple and fast switching of the display mode cannot be implemented.

### SUMMARY

According to embodiments of the disclosure, a display method of a flexible display device is provided. The method comprises: determining a state of the flexible display device according to a difference between a stress received by an upper surface and a stress received by a lower surface of the flexible display device, in which, determining the state of the flexible display device to be a planar state in a case where the stress received by the upper surface is equal to the stress received by the lower surface, and determining the state of the flexible display device to be a curved state in a case where the stress received by the upper surface is not equal to the stress received by the lower surface; and controlling the flexible display device to switch to a first display mode in a case where the state of the flexible display device is the curved state, and controlling the flexible display device to switch to a second display mode in a case where the state of the flexible display device is the planar state.

For example, the upper surface of the flexible display device is a display surface; and the determining the state of the flexible display device to be the curved state in the case where the stress received by the upper surface is not equal to the stress received by the lower surface, includes: determining the state of the flexible display device to be a curved state away from the display surface of the flexible display device in a case where the stress received by the upper surface is greater than the stress received by the lower surface; and determining the state of the flexible display device to be a curved state toward the display surface of the flexible display device in a case where the stress received by the upper surface is less than the stress received by the lower surface.

For example, the first display mode includes a split screen display mode and a black screen display mode; in a case where the state of the flexible display device is determined to be the curved state away from the display surface of the flexible display device, the flexible display device is controlled to switch to the split screen display mode; and in a case where the state of the flexible display device is determined to be the curved state toward the display surface of the flexible display device, the flexible display device is controlled to switch to the black screen display mode.

For example, the second display mode includes a full screen display mode.

For example, the determining the state of the flexible display device according to the difference between the stress received by the upper surface and the stress received by the lower surface of the flexible display device, includes: measuring the stress received by the upper surface of the flexible display device with a first pressure sensor and measuring the stress received by the lower surface of the flexible display device with a second pressure sensor; the first pressure sensor is provided closer to the upper surface of the flexible display device than the second pressure sensor, and the second pressure sensor is provided closer to the lower surface of the flexible display device than the first pressure sensor.

For example, the flexible display device further comprises a flexible display panel and a whole machine structure provided below the flexible display panel; and the first pressure sensor and the second pressure sensor are provided in one of modes below: (i) the first pressure sensor is provided on an upper surface of the whole machine structure, and the second pressure sensor is provided on a lower surface of the whole machine structure; (ii) the first pressure sensor is provided on a lower surface of the flexible display panel, and the second pressure sensor is provided on the lower surface of the whole machine structure; (iii) the first pressure sensor is provided on an upper surface of the flexible display panel, and the second pressure sensor is provided on the lower surface of the flexible display panel; (iv) the first pressure sensor is provided on the upper surface of the flexible display panel, and the second pressure sensor is provided on the upper surface of the whole machine structure; (v) the first pressure sensor is provided on the upper surface of the flexible display panel, and the second pressure sensor is provided on the lower surface of the whole machine structure; and (vi) the first pressure sensor is provided on the lower surface of the flexible display panel, and second pressure sensor is provided on the upper surface of the whole machine structure.

For example, the flexible display device includes a flexible portion and a rigid portion, and the first pressure sensor and the second pressure sensor are provided at a position corresponding to the flexible portion.

For example, a flexible thin film is provided between the first pressure sensor and a surface in contact therewith, and an area of the flexible thin film is greater than a contact area between the first pressure sensor and the surface in contact therewith; and another flexible thin film is provided between the second pressure sensor and a surface in contact therewith, and an area of the another flexible thin film is greater than a contact area between the second pressure sensor and the surface in contact therewith.

For example, the flexible display panel and the whole machine structure have a bonding region in which the flexible display panel and the whole machine structure are bonded with each other, and the first pressure sensor and the second pressure sensor are provided in the bonding region.

For example, in a direction perpendicular to the upper surface and the lower surface of the flexible display device, the first pressure sensor and the second pressure sensor overlap each other.

According to the embodiments of the disclosure, a flexible display device provided and comprises: a first pressure sensor, a second pressure sensor and a control chip. The first pressure sensor is configured to detect a stress received by an upper surface of the flexible display device, and transmit a detection result to the control chip; the second pressure sensor is configured to detect a stress received by a lower surface of the flexible display device, and transmit a detection result to the control chip; the control chip is configured to: determine a state of the flexible display device to be a planar state in a case where the stress received by the upper surface is equal to the stress received by the lower surface, and control the flexible display device to switch to a second display mode; and determine the state of the flexible display device to be a curved state in a case where the stress received by the upper surface is not equal to the stress received by the lower surface, and control the flexible display device to switch to a first display mode.

For example, the upper surface of the flexible display device is a display surface; the control chip is configured to: determine the state of the flexible display device to be a curved state away from the display surface of the flexible display device in a case where the stress received by the upper surface is greater than the stress received by the lower surface; and determine the state of the flexible display device to be a curved state toward the display surface of the flexible display device in a case where the stress received by the upper surface is less than the stress received by the lower surface.

For example, the first display mode includes a split screen display mode and a black screen display mode; the control chip is configured to: control the flexible display device to switch to the split screen display mode in a case where the state of the flexible display device is determined to be the curved state away from the display surface of the flexible display device; and control the flexible display device to switch to the black screen display mode in a case where the state of the flexible display device is determined to be the curved state toward the display surface of the flexible display device.

For example, the second display mode includes a full screen display mode.

For example, the first pressure sensor is provided closer to the upper surface of the flexible display device than the second pressure sensor, and the second pressure sensor is provided closer to the lower surface of the flexible display device than the first pressure sensor.

For example, the flexible display device comprises a flexible display panel and a whole machine structure provided below the flexible display panel; and the first pressure sensor and the second pressure sensor are provided in one of modes below: (i) the first pressure sensor is provided on an upper surface of the whole machine structure, and the second pressure sensor is provided on a lower surface of the whole machine structure; (ii) the first pressure sensor is provided on a lower surface of the flexible display panel, and the second pressure sensor is provided on the lower surface of the whole machine structure; (iii) the first pressure sensor is provided on an upper surface of the flexible display panel, and the second pressure sensor is provided on the lower surface of the flexible display panel; (iv) the first pressure sensor is provided on the upper surface of the flexible display panel, and the second pressure sensor is provided on the upper surface of the whole machine structure; (v) the first pressure sensor is provided on the upper surface of the flexible display panel, and the second pressure sensor is provided on the lower surface of the whole machine structure; and (vi) the first pressure sensor is provided on the lower surface of the flexible display panel, and second pressure sensor is provided on the upper surface of the whole machine structure.

For example, the flexible display device includes a flexible portion and a rigid portion, and the first pressure sensor and the second pressure sensor are provided at a position corresponding to the flexible portion.

For example, a flexible thin film is provided between the first pressure sensor and a surface in contact therewith, and an area of the flexible thin film is greater than a contact area between the first pressure sensor and the surface in contact therewith; and another flexible thin film is provided between the second pressure sensor and a surface in contact therewith, and an area of the another flexible thin film is greater than a contact area between the second pressure sensor and the surface in contact therewith.

For example, the flexible display panel and the whole machine structure have a bonding region in which the flexible display panel and the whole machine structure are bonded with each other, and the first pressure sensor and the second pressure sensor are provided in the bonding region.

For example, in a direction perpendicular to the upper surface and the lower surface of the flexible display device, the first pressure sensor and the second pressure sensor overlap each other.

### BRIEF DESCRIPTION OF THE DRAWINGS

In order to clearly illustrate the technical solution of the embodiments of the disclosure, the drawings of the embodiments will be briefly described in the following; it is obvious that the described drawings are only related to some embodiments of the disclosure and thus are not limitative of the disclosure.

FIG. 1 is a flow chart of a display method of a flexible display device provided by embodiments of the present disclosure;

FIG. 2 is a block diagram of a flexible display device provided by the embodiments of the present disclosure;

FIG. 3a to FIG. 3f are structural schematic diagrams of the flexible display device provided by the embodiments of the present disclosure;

FIG. 4 is a structural schematic diagram of the flexible display device provided by the embodiments of the present disclosure in a split screen display mode;

FIG. 5 is a structural schematic diagram of the flexible display device provided by the embodiments of the present disclosure in a black screen display mode;

FIG. 6 is another structural schematic diagram of the flexible display device provided by the embodiments of the present disclosure;

FIG. 7 is another structural schematic diagram of the flexible display device provided by the embodiments of the present disclosure in the split screen display mode;

FIG. 8 is another structural schematic diagram of the flexible display device provided by the embodiments of the present disclosure in the black screen display mode; and

FIG. 9 is a structural schematic diagram of mutual bonding of a flexible display panel and a whole machine structure comprised by the flexible display device provided by the embodiments of the present disclosure.

### DETAILED DESCRIPTION

In order to make objects, technical details and advantages of the embodiments of the disclosure apparent, the technical solutions of the embodiments will be described in a clearly and fully understandable way in connection with the drawings related to the embodiments of the disclosure. It is obvious that the described embodiments are just a part but not all of the embodiments of the disclosure. Based on the described embodiments herein, those skilled in the art can obtain other embodiment(s), without any inventive work, which should be within the scope of the disclosure.

Unless otherwise specified, the technical terms or scientific terms here should be of general meaning as understood by those ordinarily skilled in the art. In the specification and the claims of the present disclosure, words such as “first”, “second” and the like do not denote any order, quantity, or importance, but rather are used for distinguishing different components. Words such as “include” or “comprise” and the like denote that elements or objects appearing before the words of “include” or “comprise” cover the elements or the objects enumerated after the words of “include” or “comprise” or equivalents thereof, not exclusive of other elements or objects. Words such as “up”, “down”, “left”, “right”, “bottom”, “top”, and the like are only used for expressing relative positional relationship, when the absolute position of the described object is changed, the relative positional relationship may also be correspondingly changed.

Sizes and shapes of respective parts in the accompanying drawings do not reflect true proportions of the respective parts, but are only intended to illustrate contents of the embodiments of the present disclosure.

Hereinafter, the flexible display device and the display method thereof provided by the embodiments of the present disclosure will be described in detail in conjunction with the accompanying drawings.

As shown in FIG. 1, the embodiments of the present disclosure provide a display method of a flexible display device, comprising:

S101: determining a state of the flexible display device according to a difference between a stress received by an upper surface and a stress received by a lower surface of the flexible display device, in which, determining the state of the flexible display device to be a planar state in a case where the stress received by the upper surface is equal to the stress received by the lower surface, and determining the state of the flexible display device to be a curved state in a case where the stress received by the upper surface is not equal to the stress received by the lower surface;

S102: controlling the flexible display device to switch to a first display mode in a case where the state of the flexible display device is the curved state; and controlling the flexible display device to switch to a second display mode in a case where the state of the flexible display device is the planar state.

For example, the first display mode and the second display mode are two different display modes, the first display mode is a split screen display mode or a black screen display mode, and the second display mode is a full screen display mode. Of course, in actual applications, the first display mode and the second display mode may further be other types of display modes.

In the embodiments of the present disclosure, the state of the flexible display device is determined according to the difference between the stress received by the upper surface and the stress received by the lower surface of the flexible display device, and the flexible display device is controlled to switch to a corresponding display mode according to the state of the flexible display device; and therefore, as compared with a case where the state of the flexible display device is sensed by an infrared sensor, the state of the flexible display device is determined according to the difference between the stress received by the upper surface and stress received by the lower surface of the flexible display device according to the embodiments of the present disclosure, so that switching of the display mode is implemented simply and fast.

For example, the word “equal” in the expression “the stress received by the upper surface is equal to the stress received by the lower surface” refers to that a value of the stress received by the upper surface and a value of the stress received by the lower surface are completely the same; besides, it is also considered that the stress received by the upper surface is equal to the stress received by the lower surface in a case where the difference between the stress received by the upper surface and the stress received by the lower surface is within a preset range, and the preset range here is set according to a process flow of actual production and actual requirements of a user.

For example, the upper surface of the flexible display device is a display surface, and in the embodiments of the present disclosure, the determining the state of the flexible display device to be the curved state in the case where the stress received by the upper surface is not equal to the stress received by the lower surface, includes: determining the state of the flexible display device to be a curved state away from the display surface of the flexible display device in a case where the stress received by the upper surface is greater than the stress received by the lower surface; and determining the state of the flexible display device to be a curved state toward the display surface of the flexible display device in a case where the stress received by the upper surface is less than the stress received by the lower surface.

For example, in the embodiments of the present disclosure, in the case where the state of the flexible display device is determined to be the curved state away from the display surface of the flexible display device, the flexible display device is controlled to switch to the split screen display mode; and in the case where the state of the flexible display device is determined to be the curved state toward the display surface of the flexible display device, the flexible display device is controlled to switch to the black screen display mode.

For example, in the embodiments of the present disclosure, in the case where the state of the flexible display device is determined to be the planar state, the flexible display device is controlled to switch to the full screen display mode.

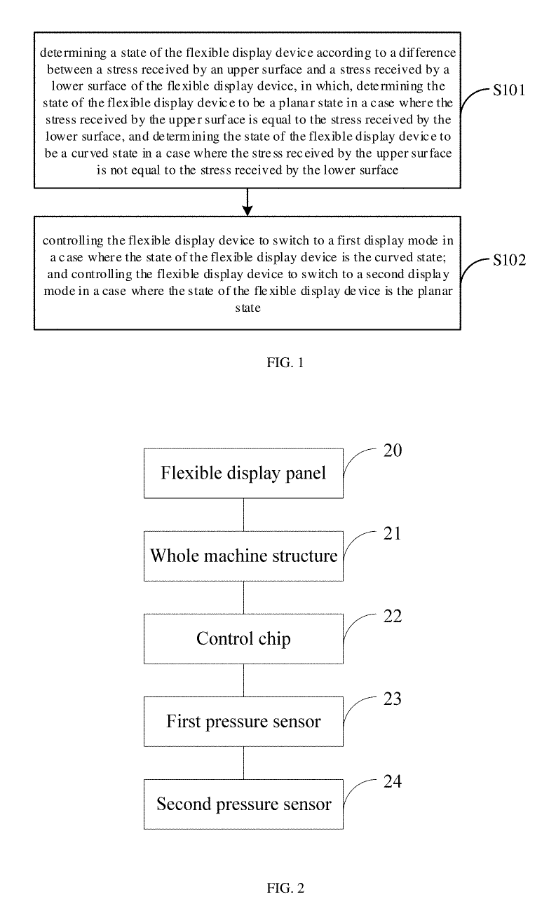

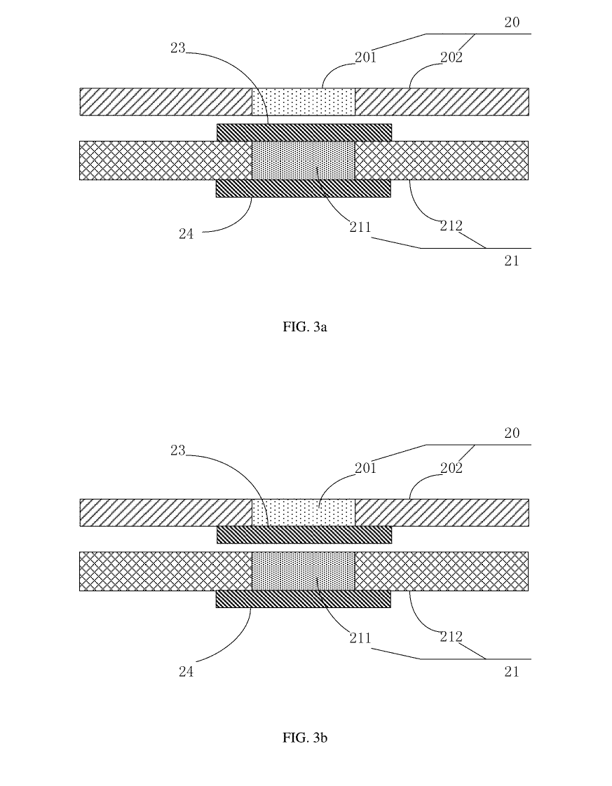

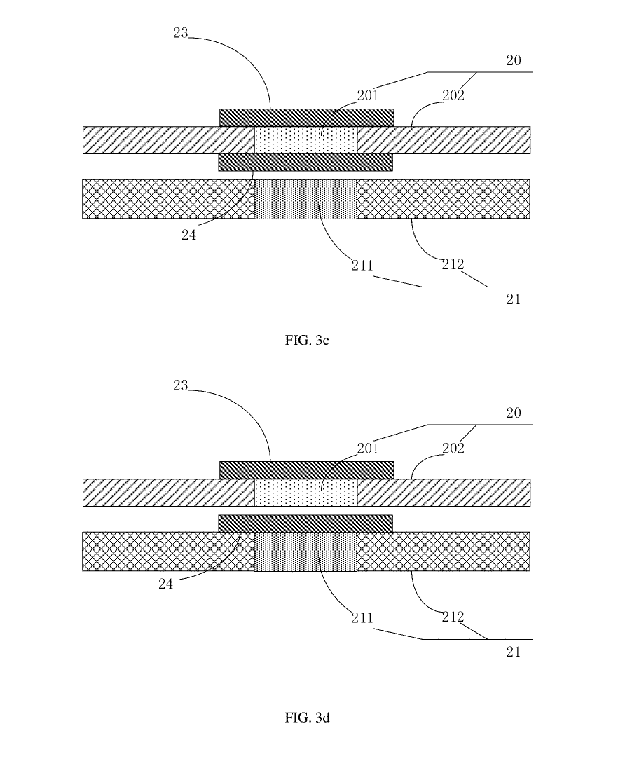

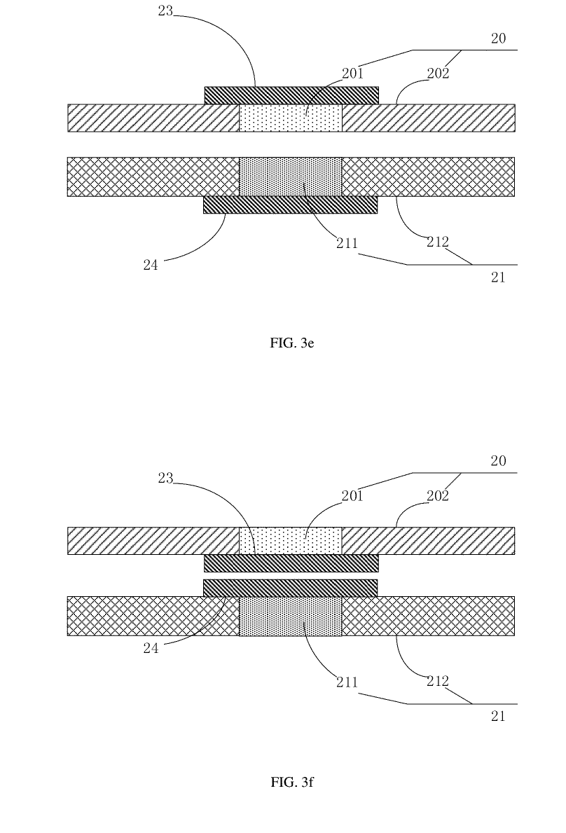

For example, with reference to FIG. 2 and FIG. 3a to FIG. 3f, the flexible display device comprises a first pressure sensor 23 and a second pressure sensor 24; and the determining the state of the flexible display device according to the difference between the stress received by the upper surface and the stress received by the lower surface of the flexible display device, includes: measuring the stress received by the upper surface of the flexible display device with the first pressure sensor 23 and measuring the stress received by the lower surface of the flexible display device with the second pressure sensor 24. For example, the first pressure sensor 23 is provided closer to the upper surface of the flexible display device than the second pressure sensor 24, and the second pressure sensor 24 is provided closer to the lower surface of the flexible display device than the first pressure sensor 23.

For example, with further reference to FIG. 2 and FIG. 3a to FIG. 3f, the flexible display device further comprises a flexible display panel 20 and a whole machine structure 21 provided below the flexible display panel 20. For example, the flexible display device further comprises a control chip 22 which is in signal connection with other structures (for example, the flexible display panel 20, the first pressure sensor 23, the second pressure sensor 24, and the like) of the flexible display device. For example, the first pressure sensor 23 and the second pressure sensor 24 are provided in one of modes below: (i) the first pressure sensor 23 is provided on an upper surface of the whole machine structure 21, and the second pressure sensor 24 is provided on a lower surface of the whole machine structure 21, as shown in FIG. 3a; (ii) the first pressure sensor 23 is provided on a lower surface of the flexible display panel 20, and the second pressure sensor 24 is provided on the lower surface of the whole machine structure 21, as shown in FIG. 3b; (iii) the first pressure sensor 23 is provided on an upper surface of the flexible display panel 20, and the second pressure sensor 24 is provided on the lower surface of the flexible display panel 20, as shown in FIG. 3c; (iv) the first pressure sensor 23 is provided on the upper surface of the flexible display panel 20, and the second pressure sensor 24 is provided on the upper surface of the whole machine structure 21, as shown in FIG. 3d; (v) the first pressure sensor 23 is provided on the upper surface of the flexible display panel 20, and the second pressure sensor 24 is provided on the lower surface of the whole machine structure 21, as shown in FIG. 3e; and (vi) the first pressure sensor 23 is provided on the lower surface of the flexible display panel 20, and second pressure sensor 24 is provided on the upper surface 21 of the whole machine structure 21, as shown in FIG. 3f.

It should be noted that, as compared with the structure shown in FIG. 3f, in the structures shown in FIG. 3(a) to FIG. 3(e), a distance between the first pressure sensor 23 and the second pressure sensor 24 is relatively far, so the difference in the stresses is also relatively large, and detection sensitivity is also relatively high.

It should be noted that, in the structures shown in FIG. 3c to FIG. 3e, the first pressure sensor 23 is provided on the upper surface of the flexible display panel 20; since the upper surface of the flexible display panel 20 is the display surface, it is necessary to provide the first pressure sensor 23 in a non-display region to avoid affecting normal display. For example, the non-display region is an edge region of the flexible display panel 20, or is a wiring region between pixel units included in the flexible display panel 20.

It should be noted that, with respect to the structures shown in FIG. 3a and FIG. 3b, not only there is a greater distance between the first pressure sensor 23 and the second pressure sensor 24, but also it is not necessary to consider impact on normal display in the case where the first pressure sensor 23 is provided.

For example, the whole machine structure 21 is a component of the flexible display device other than the flexible display panel 20, such as, a frame, a backplate, a backside protective layer, and the like. For example, the flexible display device according to the embodiments of the present disclosure may be a mobile phone, in which case, the whole machine structure 21 includes a middle frame of the mobile phone.

For example, the flexible display device comprises a flexible portion and a rigid portion, and the first pressure sensor 23 and the second pressure sensor 24 are provided at a position corresponding to the flexible portion. For example, as shown in FIG. 3a to FIG. 3f, the flexible display panel 20 includes a flexible portion 201 and a rigid portion 202; the whole machine structure 21 includes a flexible structure 211 corresponding to the position of the flexible portion 201, and a rigid structure 212 corresponding to a position of the rigid portion 202; the flexible portion of the flexible display device includes the flexible portion 201 and the flexible structure 211, and the rigid portion of the flexible display device includes the rigid portion 202 and the rigid structure 212. Detection sensitivity is improved by providing the first pressure sensor 23 and the second pressure sensor 24 at the position corresponding to the flexible portion of the flexible display device.

In a case where a stress value detected by the first pressure sensor 23 is equal to a stress value detected by the second pressure sensor 24, the control chip 22 determines the state of the flexible display device to be the planar state, that is, the state of the flexible display device is a flat plate state, as shown in FIG. 3a; at this time, the control chip 22 controls the flexible display device to display in a normal display mode (that is, the full screen display mode).

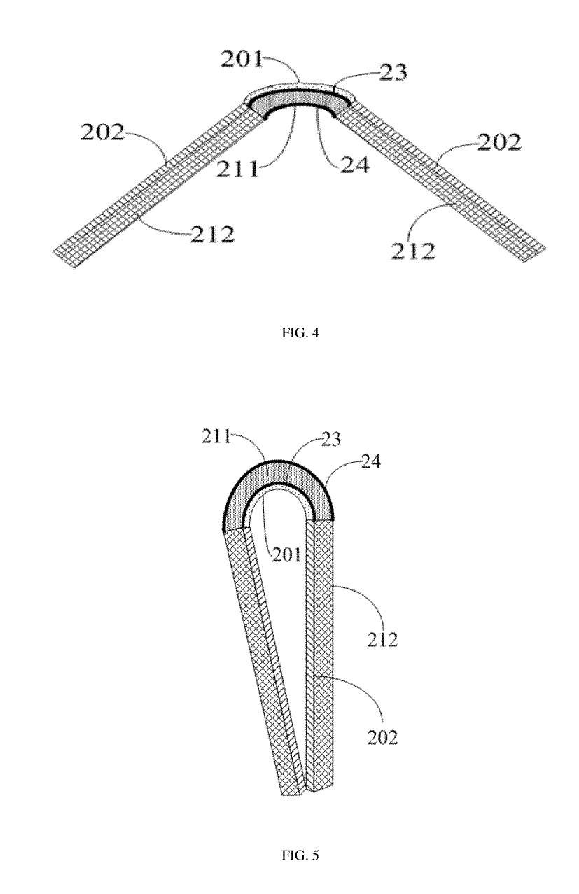

For example, with reference to FIG. 4 and FIG. 5, the split screen display mode and the black screen display mode of the display device according to the embodiments of the present disclosure are illustrated. In FIG. 4 and FIG. 5, it is explained with the structure shown in FIG. 3a that the first pressure sensor 23 is provided on the upper surface of the whole machine structure 21 and the second pressure sensor 24 is provided on the lower surface of the whole machine structure 21 as an example; however, the embodiments of the present disclosure are not limited thereto, and the split screen display mode and the black screen display mode shown in FIG. 4 and FIG. 5 are also applicable to the structures shown in FIG. 3b to FIG. 3f.

In a case where the stress value detected by the first pressure sensor 23 is greater than the stress value detected by the second pressure sensor 24, the control chip 22 determines the state of the flexible display device to be the curved state away from the display surface (a light emergent surface) of the flexible display device, that is, the state of the flexible display device is a reversely curved state, as shown in FIG. 4; at this time, the control chip 22 controls the flexible display device to display in the split screen display mode, for example, a portion of the flexible display device in FIG. 4 located on a left side of the flexible portion displays a first picture, and a portion of the flexible display device in FIG. 4 located on a right side of the flexible portion displays a second picture; the first picture and the second picture may be display pictures having a same content, or may be display pictures having different contents. In this way, during the split screen display, users in different directions simultaneously view the display pictures having a same content or having different contents.

In a case where the stress value detected by the first pressure sensor 23 is less than the stress value detected by the second pressure sensor 24, the control chip 22 determines the state of the flexible display device to be the curved state toward the display surface of the flexible display device, that is, the state of the flexible display device is a closed state; at this time, the flexible display device does not need to display a picture, as shown in FIG. 5, at which time the control chip 22 controls the flexible display device to display in the black screen display mode, so that power consumption of the flexible display device is reduced.

For example, a flexible thin film 70 is provided between the first pressure sensor 23 and a surface in contact therewith, and an area of the flexible thin film 70 is greater than a contact area between the first pressure sensor 23 and the surface in contact therewith; another flexible thin film 71 is provided between the second pressure sensor 24 and a surface in contact therewith, and an area of the another flexible thin film 71 is greater than a contact area between the second pressure sensor 24 and the surface in contact therewith. In this case, the state of the flexible display device is obtained more accurately.

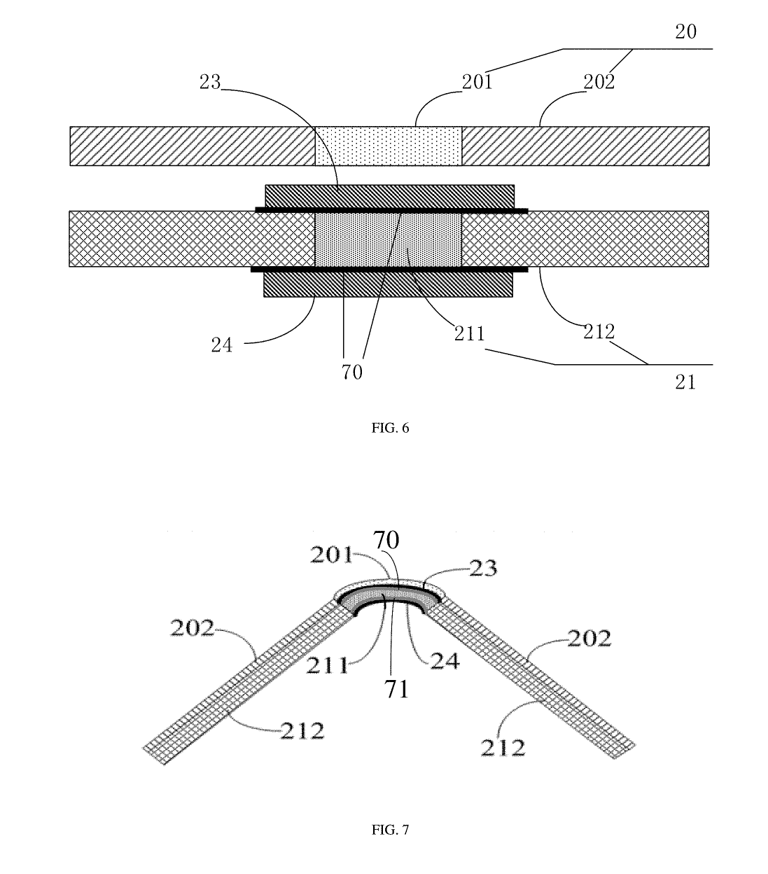

In FIG. 6, it is explained still with the structure shown in FIG. 3a that the first pressure sensor 23 is provided on the upper surface of the whole machine structure 21 and the second pressure sensor 24 is provided on the lower surface of the whole machine structure 21 as an example; however, the embodiments of the present disclosure are not limited thereto, and the flexible thin films 70 and 71 shown in FIG. 6 are also applicable to the structures shown in FIG. 3b to FIG. 3f. In FIG. 6, the flexible thin film 70 is provided between the first pressure sensor 23 and the upper surface of the whole machine structure 21, and the flexible thin film 71 is provided between the second pressure sensor 24 and the lower surface of the whole machine structure 21.

For example, the area of the flexible thin film 70 is equal to the area of the flexible thin film 71, and thus, comparability between the stress measured by the first pressure sensor 23 and the stress measured by the second pressure sensor 24 is stronger, so that accuracy is higher in a case where the display state of the display device is determined according to the difference in the stresses.

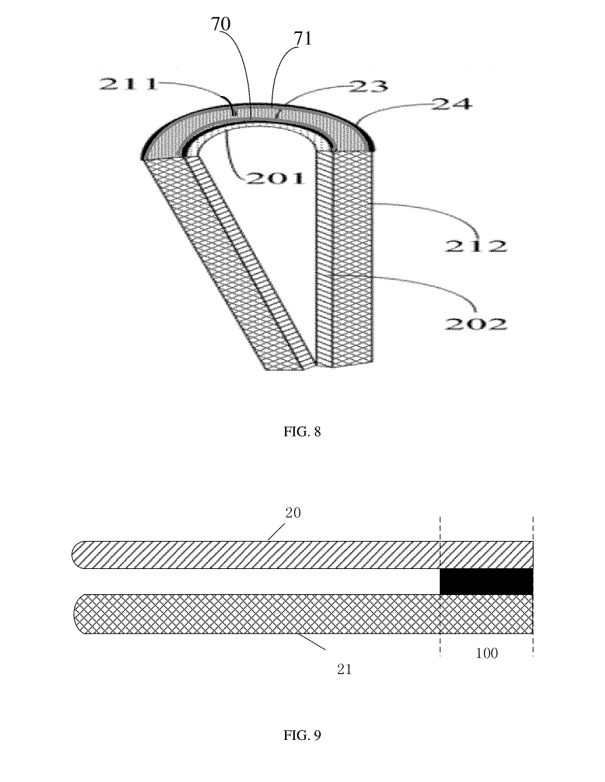

For example, with reference to FIG. 7 to FIG. 8, the split screen display mode and the black screen display mode of the display device shown in FIG. 6 are illustrated. Through provision of the flexible thin films 70 and 71, the state of the display device is determined more accurately.

For example, as shown in FIG. 9, the flexible display panel 20 and the whole machine structure 21 have a bonding region 100 in which the flexible display panel 20 and the whole machine structure 21 are bonded with each other. For example, in the bonding region 100, the flexible display panel 20 and the whole machine structure 21 are bonded together through bolts, or other fixing members. For example, the first pressure sensor 23 and the second pressure sensor 24 are provided in the bonding region 100. In the bonding region 100, the flexible display panel 20 and the whole machine structure 21 have a strong interaction force therebetween, so detectable difference in the stresses is also relatively large, so that detection sensitivity is also relatively high.

For example, in a direction perpendicular to the upper surface and the lower surface of the flexible display device, the first pressure sensor 23 and the second pressure sensor 24 overlap each other. Further, for example, in the direction perpendicular to the upper surface and the lower surface of the flexible display device, the first pressure sensor 23 and the second pressure sensor 24 completely overlap each other. In this way, comparability between the stress measured by the first pressure sensor 23 and the stress measured by the second pressure sensor 24 is stronger, so that accuracy is higher in the case where the display state of the display device is determined according to the difference in the stresses.

For example, the embodiments of the present disclosure further provide a flexible display device. As shown in FIG. 2, the flexible display device comprises the control chip 22, the first pressure sensor 23 and the second pressure sensor 24. The first pressure sensor 23 is configured to detect the stress received by the upper surface of the flexible display device, and transmit a detection result to the control chip 22; the second pressure sensor 24 is configured to detect the stress received by the lower surface of the flexible display device, and transmit a detection result to the control chip 22; the control chip 20 is configured to: determine the state of the flexible display device to be the planar state in the case where the stress received by the upper surface is equal to the stress received by the lower surface, and control the flexible display device to switch to the second display mode; and determine the state of the flexible display device to be the curved state in the case where the stress received by the upper surface is not equal to the stress received by the lower surface, and control the flexible display device to switch to the first display mode.

For example, the upper surface of the flexible display device is the display surface; and the control chip 22 is configured to: determine the state of the flexible display device to be the curved state away from the display surface of the flexible display device in the case where the stress received by the upper surface is greater than the stress received by the lower surface; and determine the state of the flexible display device to be the curved state toward the display surface of the flexible display device in the case where the stress received by the upper surface is less than the stress received by the lower surface.

For example, the control chip 22 is further configured to: control the flexible display device to switch to the split screen display mode in the case where the state of the flexible display device is determined to be the curved state away from the display surface of the flexible display device; and control the flexible display device to switch to the black screen display mode in the case where the state of the flexible display device is determined to be the curved state toward the display surface of the flexible display device.

For example, the control chip is further configured to: control the flexible display device to switch to the full screen display mode in the case where the stress received by the upper surface is equal to the stress received by the lower surface.

For example, the flexible display device according to the embodiment of the present disclosure further comprises the flexible display panel 20 and the whole machine structure 21 provided below the flexible display panel 20. For example, the control chip 22 according to the embodiments of the present disclosure is directly integrated on the flexible display panel 20, or is integrated on a drive integrated circuit that drives the flexible display panel 20 to operate. Thus, a provision mode of the control chip 22 according to the embodiments of the present disclosure is simpler, more flexible and changeable. For example, the flexible display device according to the embodiments of the present disclosure is the mobile phone, and at this time, the control chip 22 controls a display screen of the mobile phone to display in a mobile phone mode.

It should be noted that, in the flexible display device according to the embodiments of the present disclosure, the description in the above-described display method embodiments may be referred to for a provision mode of the first pressure sensor 23 and the second pressure sensor 24, which will not be repeated herein.

It should be noted that, the flexible display device according to the embodiments of the present disclosure may further comprise flexible thin films 70 and 71, and the description in the above-described display method embodiments may be referred to for a provision mode thereof, which will not be repeated herein.

In the embodiments of the present disclosure, the state of the flexible display device is determined according to the difference between the stress received by the upper surface and the stress received by the lower surface of the flexible display device, and the flexible display device is controlled to switch to the corresponding display mode according to the state of the flexible display device; and therefore, as compared with the case where the state of the flexible display device is sensed by the infrared sensor, the state of the flexible display device is determined according to the difference between the stress received by the upper surface and the stress received by the lower surface of the flexible display device according to the embodiments of the present disclosure, so that switching of the display mode is implemented simply and fast.

The foregoing embodiments merely are exemplary embodiments of the present disclosure, and not intended to define the scope of the present disclosure, and the scope of the present disclosure is determined by the appended claims.

1. A display method of a flexible display device, comprising:
determining a state of the flexible display device according to a difference between a stress received by an upper surface and a stress received by a lower surface of the flexible display device, in which, determining the state of the flexible display device to be a planar state in a case where the stress received by the upper surface is equal to the stress received by the lower surface, and determining the state of the flexible display device to be a curved state in a case where the stress received by the upper surface is not equal to the stress received by the lower surface; and
controlling the flexible display device to switch to a first display mode in a case where the state of the flexible display device is the curved state, and controlling the flexible display device to switch to a second display mode in a case where the state of the flexible display device is the planar state.

2. The display method according to claim 1, wherein,
the upper surface of the flexible display device is a display surface; and
the determining the state of the flexible display device to be the curved state in the case where the stress received by the upper surface is not equal to the stress received by the lower surface, includes: determining the state of the flexible display device to be a curved state away from the display surface of the flexible display device in a case where the stress received by the upper surface is greater than the stress received by the lower surface; and determining the state of the flexible display device to be a curved state toward the display surface of the flexible display device in a case where the stress received by the upper surface is less than the stress received by the lower surface.

3. The display method according to claim 2, wherein,
the first display mode includes a split screen display mode and a black screen display mode;
in a case where the state of the flexible display device is determined to be the curved state away from the display surface of the flexible display device, the flexible display device is controlled to switch to the split screen display mode; and
in a case where the state of the flexible display device is determined to be the curved state toward the display surface of the flexible display device, the flexible display device is controlled to switch to the black screen display mode.

4. The display method according to claim 1, wherein, the second display mode includes a full screen display mode.

5. The display method according to claim 1, wherein,
the determining the state of the flexible display device according to the difference between the stress received by the upper surface and the stress received by the lower surface of the flexible display device, includes: measuring the stress received by the upper surface of the flexible display device with a first pressure sensor and measuring the stress received by the lower surface of the flexible display device with a second pressure sensor,
the first pressure sensor is provided closer to the upper surface of the flexible display device than the second pressure sensor, and the second pressure sensor is provided closer to the lower surface of the flexible display device than the first pressure sensor.

6. The display method according to claim 5, wherein,
the flexible display device further comprises a flexible display panel and a whole machine structure provided below the flexible display panel; and
the first pressure sensor and the second pressure sensor are provided in one of modes below:
(i) the first pressure sensor is provided on an upper surface of the whole machine structure, and the second pressure sensor is provided on a lower surface of the whole machine structure;
(ii) the first pressure sensor is provided on a lower surface of the flexible display panel, and the second pressure sensor is provided on the lower surface of the whole machine structure;
(iii) the first pressure sensor is provided on an upper surface of the flexible display panel, and the second pressure sensor is provided on the lower surface of the flexible display panel;
(iv) the first pressure sensor is provided on the upper surface of the flexible display panel, and the second pressure sensor is provided on the upper surface of the whole machine structure;
(v) the first pressure sensor is provided on the upper surface of the flexible display panel, and the second pressure sensor is provided on the lower surface of the whole machine structure; and
(vi) the first pressure sensor is provided on the lower surface of the flexible display panel, and second pressure sensor is provided on the upper surface of the whole machine structure.

7. The display method according to claim 5, wherein,
the flexible display device includes a flexible portion and a rigid portion, and the first pressure sensor and the second pressure sensor are provided at a position corresponding to the flexible portion.

8. The display method according to claim 5, wherein,
a flexible thin film is provided between the first pressure sensor and a surface in contact therewith, and an area of the flexible thin film is greater than a contact area between the first pressure sensor and the surface in contact therewith; and
another flexible thin film is provided between the second pressure sensor and a surface in contact therewith, and an area of the another flexible thin film is greater than a contact area between the second pressure sensor and the surface in contact therewith.

9. The display method according to claim 6, wherein,
the flexible display panel and the whole machine structure have a bonding region in which the flexible display panel and the whole machine structure are bonded with each other, and the first pressure sensor and the second pressure sensor are provided in the bonding region.

10. The display method according to claim 5, wherein, in a direction perpendicular to the upper surface and the lower surface of the flexible display device, the first pressure sensor and the second pressure sensor overlap each other.

11. A flexible display device, comprising: a first pressure sensor, a second pressure sensor and a control chip, wherein,
the first pressure sensor is configured to detect a stress received by an upper surface of the flexible display device, and transmit a detection result to the control chip;
the second pressure sensor is configured to detect a stress received by a lower surface of the flexible display device, and transmit a detection result to the control chip;
the control chip is configured to: determine a state of the flexible display device to be a planar state in a case where the stress received by the upper surface is equal to the stress received by the lower surface, and control the flexible display device to switch to a second display mode; and determine the state of the flexible display device to be a curved state in a case where the stress received by the upper surface is not equal to the stress received by the lower surface, and control the flexible display device to switch to a first display mode.

12. The flexible display device according to claim 11, wherein,
the upper surface of the flexible display device is a display surface;
the control chip is configured to: determine the state of the flexible display device to be a curved state away from the display surface of the flexible display device in a case where the stress received by the upper surface is greater than the stress received by the lower surface; and determine the state of the flexible display device to be a curved state toward the display surface of the flexible display device in a case where the stress received by the upper surface is less than the stress received by the lower surface.

13. The flexible display device according to claim 12, wherein,
the first display mode includes a split screen display mode and a black screen display mode;
the control chip is configured to: control the flexible display device to switch to the split screen display mode in a case where the state of the flexible display device is determined to be the curved state away from the display surface of the flexible display device; and control the flexible display device to switch to the black screen display mode in a case where the state of the flexible display device is determined to be the curved state toward the display surface of the flexible display device.

14. The flexible display device according to claim 11, wherein, the second display mode includes a full screen display mode.

15. The flexible display device according to claim 11, wherein, the first pressure sensor is provided closer to the upper surface of the flexible display device than the second pressure sensor, and the second pressure sensor is provided closer to the lower surface of the flexible display device than the first pressure sensor.

16. The flexible display device according to claim 15, wherein,
the flexible display device comprises a flexible display panel and a whole machine structure provided below the flexible display panel; and
the first pressure sensor and the second pressure sensor are provided in one of modes below:
(i) the first pressure sensor is provided on an upper surface of the whole machine structure, and the second pressure sensor is provided on a lower surface of the whole machine structure;
(ii) the first pressure sensor is provided on a lower surface of the flexible display panel, and the second pressure sensor is provided on the lower surface of the whole machine structure;
(iii) the first pressure sensor is provided on an upper surface of the flexible display panel, and the second pressure sensor is provided on the lower surface of the flexible display panel;
(iv) the first pressure sensor is provided on the upper surface of the flexible display panel, and the second pressure sensor is provided on the upper surface of the whole machine structure;
(v) the first pressure sensor is provided on the upper surface of the flexible display panel, and the second pressure sensor is provided on the lower surface of the whole machine structure; and
(vi) the first pressure sensor is provided on the lower surface of the flexible display panel, and second pressure sensor is provided on the upper surface of the whole machine structure.

17. The flexible display device according to claim 15, wherein,
the flexible display device includes a flexible portion and a rigid portion, and the first pressure sensor and the second pressure sensor are provided at a position corresponding to the flexible portion.

18. The flexible display device according to claim 15, wherein,
a flexible thin film is provided between the first pressure sensor and a surface in contact therewith, and an area of the flexible thin film is greater than a contact area between the first pressure sensor and the surface in contact therewith; and
another flexible thin film is provided between the second pressure sensor and a surface in contact therewith, and an area of the another flexible thin film is greater than a contact area between the second pressure sensor and the surface in contact therewith.

19. The flexible display device according to claim 16, wherein,
the flexible display panel and the whole machine structure have a bonding region in which the flexible display panel and the whole machine structure are bonded with each other, and the first pressure sensor and the second pressure sensor are provided in the bonding region.

20. The flexible display device according to claim 15, wherein, in a direction perpendicular to the upper surface and the lower surface of the flexible display device, the first pressure sensor and the second pressure sensor overlap each other.
